(19) United States
(12) Patent Application Publication
(10) Pub. No.: US 2003/0009752 A1
(43) Pub. Date: Jan. 9, 2003

(54) Automated content and software distribution system

(76) Inventor: Arvind Gupta, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/898,568

(22) Filed: Jul. 3, 2001

(51) Int. Cl. G06F 9/44

(52) U.S. Cl. 717/171

(57) ABSTRACT

A new use for an application program installer, such as the Microsoft Windows Software Installer (MSI) Application, which is operable to install an application program and rollback an installation if it appears unsuccessful, and a backup-restore application program, such as such as Tivoli Backup™, which is operable to backup and restore a configuration of a machine. An update for altering network resources of a customer being hosted on one or more hosting servers of a hosting service is provided. A first server of the hosting servers is selected. A starting configuration of the first server is backed up. The application program installer is utilized to apply the update to the network resources of the customer on the first server. A determination may be made whether to restore the starting configuration of the first server with the backup-restore application program. Thus, in contrast with its normal operational use as an application program installer, MSI or equivalent software can be configured to apply upgrades, e.g., patches, etc., to the network resources of the customer, and Tivoli or equivalent software may be used to recover from defective upgrades, such as errors due to improper operation of the network resources.

### FIELD OF THE INVENTION

The invention generally relates to content distribution, and more particularly to a content management system in which content updates received from a client, for content hosted by a hosting service, are automatically applied in a fail-safe manner to servers hosting the content for the client.

### BACKGROUND

In recent years there has been significant build-up in network infrastructure. Most notably, the Internet has grown such that most businesses and home users are able to obtain a robust network connection and engage in online transactions. Many businesses take advantage of the ability to transact with customers over a network, such as the Internet, by providing online retail services. Unfortunately, there are significant server acquisition costs, technical hurdles, and security issues related to providing a secure and reliable online retail site, e.g., creating and maintaining network content, safely receiving and processing credit card data, protecting private consumer data, etc. Frequently, there are news articles discussing how a business' online stores were broken into by computer vandals, and online presences altered and/or consumer data compromised.

To alleviate such risks, third party hosting services offer hosting services, where the hosting service is responsible for safely maintaining and providing a client's networked content, e.g., web pages, online stores, software distribution, etc. Typically, the client prepares its content on a production machine, and once it is working as desired, provides it to the hosting service. Assuming multiple servers host the client content, the hosting service mirrors the client content across the servers, and uses load balancing techniques to provide efficient access to the client content.

Eventually, the client needs to update its content. This may happen frequently. For example, in an online retail environment, there may be one or more daily updates to pricing data within the content. To effect an update, the hosting service requires the client to provide the update, e.g., replacement files, a script to edit database entries, etc., to the hosting service, which in turn manually applies the changes to the hosted content. When multiple servers are used to host the client content, then these manual changes are manually applied across all hosting servers. Unfortunately, this manual processing is time consuming and error prone. And, undesirable results occur when updates are not consistently applied to all servers hosting the client content.

### BRIEF DESCRIPTION OF THE DRAWINGS

The features and advantages of the present invention will become apparent from the following detailed description of the present invention in which:

FIG. 1 illustrates an exemplary system according to one embodiment of the invention for automating updates to client content hosted by a hosting service.

FIG. 2 is a flowchart according to one embodiment for automatically applying, and recovering from, if necessary, an update to network resources hosted for a client.

FIG. 3 illustrates a suitable computing environment in which certain aspects of the invention may be implemented.

### DETAILED DESCRIPTION

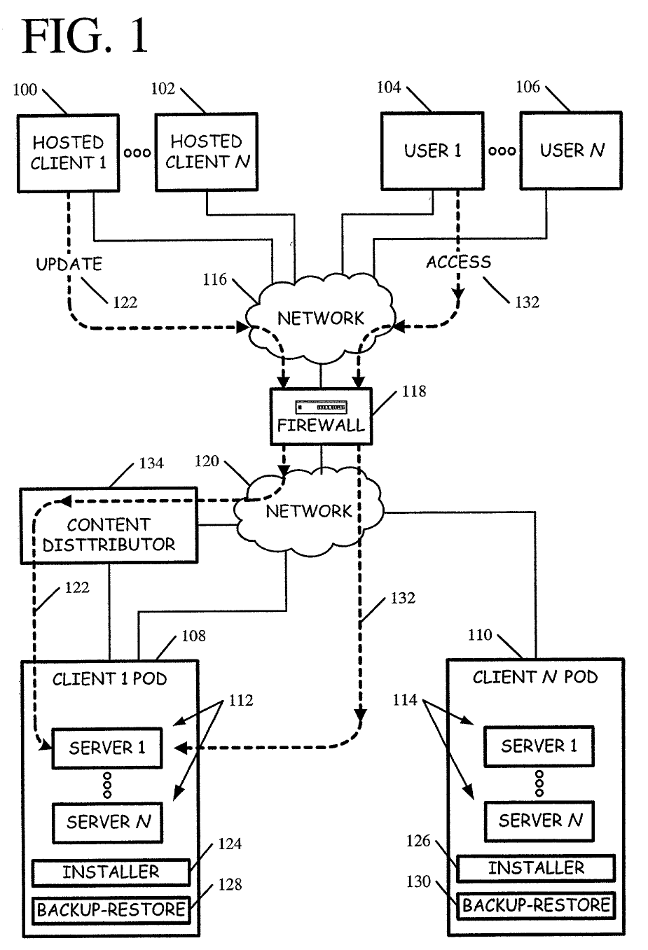

FIG. 1 illustrates an exemplary system according to one embodiment of the invention for automating updates to client content hosted by a hosting service.

Shown are hosted clients 1 through N 100, 102 (“N” indicates an arbitrarily large number). Hosted clients have web sites and data, e.g., music, videos, application programs, databases, documents, other networked resources, etc. (hereafter “network resources”) that are accessed 132 by users 1 through N 104, 106.

To alleviate administrative burdens related to providing the network resources to users 104, 106, the network resources are hosted by a hosting service which provides each hosted client 100, 102 a respective hosted client POD 1 through N 108, 110. The term “POD” references a physical and/or logical collection of servers 1 through N 112, 114 and/or other machines or devices (not illustrated) used to serve a hosted client's network resources. Load balancing or other distribution techniques, not illustrates, may be used to distribute access 116 to the network resources across the servers 112, 114.

The hosted clients 100, 102, users 104, 106, and PODs 108, 110 are all in communication by way of a network 116 such as an intranet, the Internet, or other wired and/or wireless network. In illustrated embodiments, access to the PODs is regulated by a firewall 118 in communication with the PODs over a private network 120. Private network 120 may be a separate network, or may use privatized sub-portions of network 116, such as through use of virtual private network technology. The term “firewall,” as used herein, represents functionality for employing a large variety of security techniques and access control methods designed to regulate and restrict access to the private network 120 and machines attached thereto. Firewall 118 is assumed to include functionality for routing incoming connection types to different destinations.

It will be appreciated by one skilled in the art that the firewall may physically comprise a single machine, or multiple distributed machines, each having embedded or associated software and/or hardware for performing certain tasks. Assuming the firewall 118 is trusted to properly block unauthorized intrusions, machines behind the firewall may employ reduced security measures than otherwise required for a machine directly connected to network 116. Since managing security is a complex task, and there may be potentially numerous machines behind the firewall, the firewall greatly reduces administrative burdens on maintaining the hosting servers.

A client is responsible for providing an update 122 for its hosted network resources. As discussed above, significant issues may arise when applying the update to multiple servers in a POD. In particular, since updates are at least partially manually applied to each server within a POD, human and/or mechanical error during the manual process leaves room for errors to occur, which may result in different states on different servers within a POD. This may cause significant problems. For example, if misapplied updates leave different server pricing databases out of sync with each other, this may result is loss of revenue and/or loss of clients.

To resolve this problem, in one embodiment, hosted network resources are updated automatically, for all servers, using conventional software installation programs 124, 126, such as the Microsoft Windows Software Installer (MSI) Application, and conventional system backup and restore 128, 130 (“backup-restore”) software, such as Tivoli Backup. (Please note TIVOLI is a trademark of Tivoli Systems, Inc., and that other marks used herein are the property of their respective owners.)

The firewall 118 is configured to distinguish between customer updates 122 and client accesses 132 to the hosted client data. The firewall directs customer updates to a content distributor 134, which in turn controls use of the software installation program 124, 126 and the backup-restore software and the 128, 130. Regular client access 132, e.g., an attempt to access a web page, download a data file, load a video, etc., is simply routed to one of the servers in a POD which provides access to the requested resource. (Not illustrated is the software and/or hardware for directing the access to an appropriate server in a POD.)

In another embodiment, not illustrated, the firewall does not distinguish between incoming connections, and instead connections pass through according to the configuration of the incoming connection. For example, for providing an update, a hosted client is required to utilize a particular communication protocol and/or communication port. For accessing a web page, a user accesses a certain web address for which domain name servers (DNS) are configured to direct accesses to the firewall, which in turn redirects the access to an appropriate POD.

MSI, and equivalent software, manages installation of software, and manages additions and deletions of software components, monitors file resiliency, and provides basic disaster recovery. MSI supports installing and running software from multiple sources, provides platform specific security, and robust support for prerequisites, e.g., disk checks, CPU checks, etc. MSI also supports variables during deployment, and component level dependency checking. A hosted client prepares an update to its hosted network resources by preparing an MSI installation that results in a patch to the hosted network resources. When the update is applied, if MSI detects an installation error, MSI can rollback a computer system to a pre-installation state, e.g., undo all changes made to the system during the program installation process.

However, MSI, and equivalent software, has several shortcomings. Rollbacks are often unreliable, and may leave a system unstable. MSI may erroneously report a valid installation, and not recognize when a rollback is needed. And, MSI can not account for abnormal program operation for a correctly installed program. For example, an update may include an application program that incorrectly updates a database. Also, MSI cannot correct errors that incapacitate the operating system. It will be appreciated that there are many other circumstances where a installation may be deemed to have failed, necessitating a rollback to a pre-update state.

In such circumstances, rather than rely on the installer 124, 126, e.g., MSI, to rollback a from failed update, instead the backup-restore application 128, 130, e.g., Tivoli, is used to recover a pre-installation system state prior to attempting the update. To do so, Tivoli is used to take a snapshot of a system's state prior to attempting the client's update 122. On determining a problem with an update, Tivoli is used to rollback to a pre-installation state of the system. Tivoli also allows site-versioning to allow rolling back to different versions of a hosted client's network resources.

To simplify application of the client update, in one embodiment, the update is only applied to Server 1 within a POD, e.g., POD 112. If the update is determined to be successful, then the successfully updated server is replicated across the other servers within the POD. But, If the update is not successful, then Tivoli is only required to rollback Server 1 to its pre-installation state.

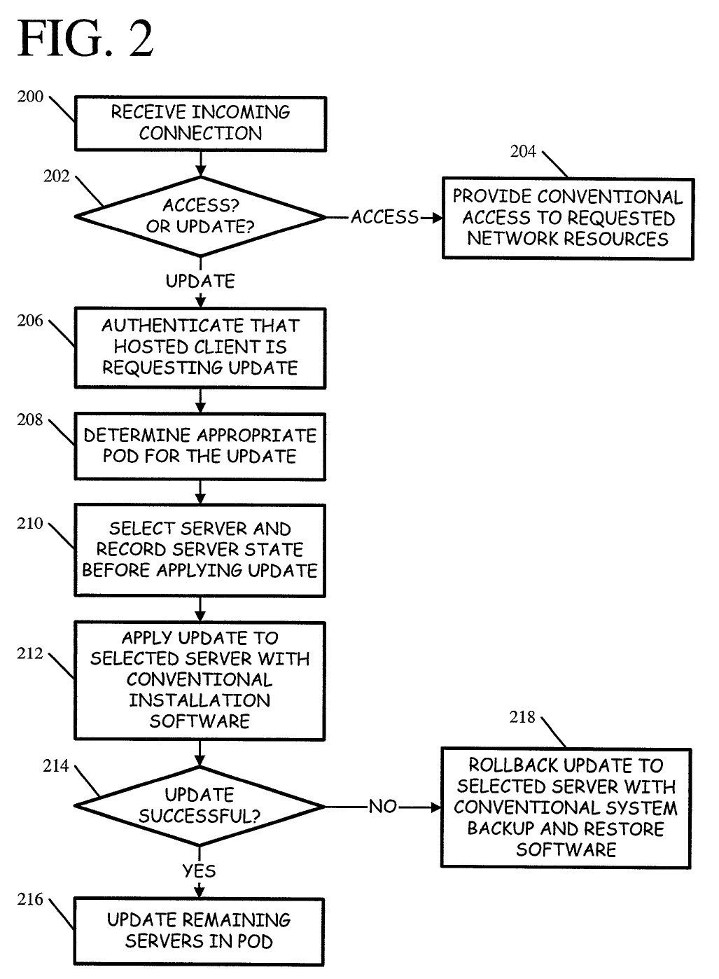

FIG. 2 is a flowchart according to one embodiment for automatically applying, and recovering from, if necessary, an update to network resources hosted for a client, e.g., hosted by Client 1 POD 108.

An incoming connection from a user 104, 106 is received 200 by a firewall 118 (FIG. 1), which, as discussed above, shields access to Client PODs 108, 110. Assuming the firewall is configured to direct incoming connections, the firewall (or associated hardware and/or software) determines whether the incoming connection is an update, or an attempt to access network resources on a POD. If 202 the incoming connection corresponds to an access 132 attempt from a user, the access is provided 204 to the hosted client's POD for conventional processing by the POD. If 202 the incoming connection corresponds to an update 122 from a hosted client, then, in one embodiment, the client is authenticated 206 to ensure the update is authorized.

The received 200 update is assumed directly received from the hosted client. However, it will be appreciated the update may come from another source, such as a third-party responsible for developing and/or maintaining the client's network resources. A POD may comprise a physical and/or logical grouping of machines in different geographical locations. Also, a client may have multiple PODs for different network resources, for example, different storefronts. Thus, an appropriate POD for the received update is determined 208. The received update is applied to a selected one of the servers in the appropriate POD. For simplicity, it is assumed that the first server is always selected to receive the update. However, it will be appreciated that it may sometimes be advantageous to apply a selection process for determining the server to upgrade, such as to avoid a server that is busy.

Before applying the update to the selected server, a system state of the selected server is recorded 210. As discussed above, a snapshot of the selected server's system state may be determined with Tivoli backup software, or other comparable software and/or hardware that can record the state of the server, to allow a rollback if the update fails. In one embodiment, the server hardware comprises an application program stored in nonvolatile memory to facilitate rolling back an update that results in an operating system that can not boot, or otherwise impedes the operating system's normal operation.

After the system state has been determined, a content distributor 134 directs a conventional software installation program, e.g., MSI or an equivalent program, to apply 212 the update to the selected server. After applying the update, a test, or tests, is performed to determine if 214 the update succeeded. If the update appears successful, then remaining servers within the POD are also updated 216 with the software installation program. In one embodiment, to reduce possibility of error in applying the update to the other servers within the POD, instead of applying the update to the other servers in the POD, instead the successfully updated server is replicated onto the remaining servers.

If 214 the update appears unsuccessful, the content distributor 134 directs the conventional system backup and restore software, e.g., Tivoli, to roll back 218 the updated server to its previously determined 210 state. If the update appears successful, then the remaining servers in the POD are updated 216. In one embodiment, for efficiency, rather applying the update to the remaining servers in a POD, instead the successfully updated server is replicated onto the remaining servers, e.g., states of the remaining servers are replaced with the state of the updated server.

Thus, illustrated embodiments provide an automated way to handle a hosted client's day to day and software change management needs in a hosting service data center. From the hosted client's point of view, automation provides higher availability, higher customer satisfaction (e.g., satisfaction of users 104, 106), and higher revenue potentials.

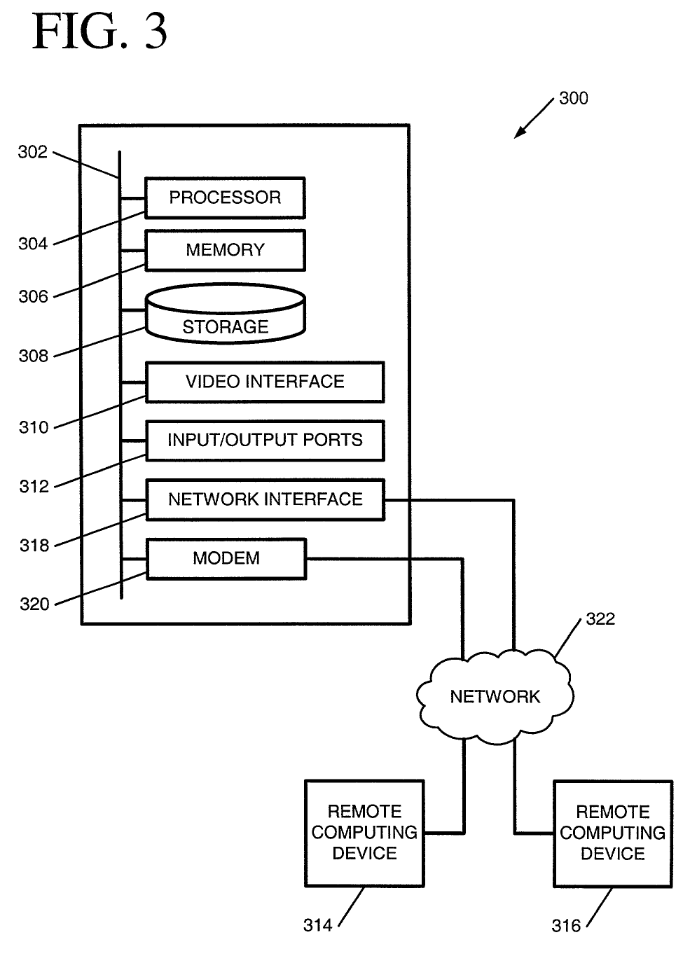

FIG. 3 and the following discussion are intended to provide a brief, general description of a suitable computing environment in which certain aspects of the illustrated invention may be implemented. An exemplary system for embodying, for example, the Servers 112, 114 or the users 104, 106 of FIG. 1, includes a machine 300 having system bus 302 for coupling various machine components which may be used to determine a state of the machine. Typically, attached to the bus are processors 304, a memory 306 (e.g., RAM, ROM), storage devices 308, a video interface 310, and input/output interface ports 312.

The system may also include embedded controllers, such as Generic or Programmable Logic Devices or Arrays (PLD, PLA, GAL, PAL), Field-Programmable Gate Arrays (FPGA), Application Specific Integrated Circuits (ASIC), single-chip computers, smart cards, or the like, and the system is expected to operate in a networked environment using physical and/or logical connections to one or more remote systems 314, 316 through a network interface 318, modem 320, or other data pathway. Systems may be interconnected by way of a wired or wireless network 322, such as the networks 116, 120 of FIG. 1, including an intranet, the Internet, local area networks, wide area networks, cellular, cable, laser, satellite, microwave, short-range networks such as “Blue Tooth,” optical, infrared, or other carrier.

The invention may be described by reference to program modules for performing tasks or implementing abstract data types, e.g., procedures, functions, data structures, application programs, etc., that may be stored in memory 306 and/or storage devices 308 and associated storage media, e.g., hard-drives, floppy-disks, optical storage, magnetic cassettes, tapes, flash memory cards, memory sticks, digital video disks, biological storage, as well as transmission environments such as network 322 over which program modules may be delivered in the form of packets, serial data, parallel data, signal wave forms, or other transmission format.

Illustrated methods and corresponding written descriptions are intended to illustrate machine-accessible media storing directives, or the like, which may be incorporated into single and multi-processor machines, portable computers, such as handheld devices including Personal Digital Assistants (PDAs), cellular telephones, etc. An artisan will recognize that program modules may be high-level programming language constructs, or low-level hardware instructions and/or contexts, that may be utilized in a compressed or encrypted format, and may be used in a distributed network environment and stored in local and/or remote memory.

Thus, for example, with respect to the illustrated embodiments, assuming machine 300 operates as a Hosted Client 1 100, then remote devices 314, 316 may respectively be the Content Distributor 134 and Client 1 POD 108. It will be appreciated that remote machines 314, 316 may be configured like machine 300, and therefore include many or all of the elements discussed for machine. It should also be appreciated that machines 300, 314, 316 may be embodied within a single device, or separate communicatively-coupled components.

Having described and illustrated the principles of the invention with reference to illustrated embodiments, it will be recognized that the illustrated embodiments can be modified in arrangement and detail without departing from such principles. And, even though the foregoing discussion has focused on particular embodiments, it is understood other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments, and unless indicated otherwise, embodiments are combinable into other embodiments.

Consequently, in view of the wide variety of permutations to the above-described embodiments, the detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method, comprising:
providing an update for altering network resources of a customer being hosted on one or more hosting servers of a hosting service;
selecting a first server of the hosting servers;
backing up a starting configuration of the first server;
utilizing an application program installer to apply the update to the network resources of the customer on the first server; and
determining whether to restore the starting configuration of the first server with a backup-restore application program.

2. The method of claim 1, further comprising:
determining the application program installer incorrectly identified a successful installation of the update to the network resources of the customer on the first server; and
restoring the starting configuration of the first server with the backup-restore application program.

3. The method of claim 1, further comprising:
selecting a second server of the hosting servers; and
replicating the first server onto the second server after utilizing the application program installer to apply the update to the network resources of the customer on the first server.

4. The method of claim 1, further comprising:
selecting a second server of the hosting servers; and
utilizing the application program installer to apply the update to the network resources of the customer on the second server.

5. The method of claim 1, wherein the update comprises differences between the network resources of the customer hosted by the hosting service and a new version of the network resources prepared by the customer.

6. The method of claim 1, further comprising:
wherein the application program installer is utilized to install updates to selected ones of Internet data files, database records, and software applications.

7. A machine accessible medium having instructions associated therewith, which when executed by a processor, are capable of directing the processor to perform:
providing an update for altering network resources of a customer being hosted on one or more hosting servers of a hosting service;
selecting a first server of the hosting servers;
backing up a starting configuration of the first server;
utilizing an application program installer to apply the update to the network resources of the customer on the first server; and
determining whether to restore the starting configuration of the first server with a backup-restore application program.

8. The medium of claim 7, said instructions comprising further instructions capable of directing the processor to perform:
determining the application program installer incorrectly identified a successful installation of the update to the network resources of the customer on the first server; and
restoring the starting configuration of the first server with the backup-restore application program.

9. The medium of claim 7, said instructions comprising further instructions capable of directing the processor to perform:
selecting a second server of the hosting servers; and
replicating the first server onto the second server after utilizing the application program installer to apply the update to the network resources of the customer on the first server.

10. The medium of claim 7, said instructions comprising further instructions capable of directing the processor to perform:
selecting a second server of the hosting servers; and
utilizing the application program installer to apply the update to the network resources of the customer on the second server.

11. The medium of claim 7, wherein the update comprises differences between the network resources of the customer hosted by the hosting service and a new version of the network resources prepared by the customer.

12. The medium of claim 7, wherein the application program installer is utilized to install updates to selected ones of Internet data files, database records, and software applications.

13. A system implementing a new use for an application program installer operable to install an application program and rollback an installation if it appears unsuccessful, and a backup-restore application program operable to backup and restore a configuration of a machine, the system comprising:
a public network communicatively coupling a customer and a firewall;
a private network communicatively coupling the firewall, a content distributor, and a POD comprising hosting servers hosting network resources of the customer;
wherein an update from the customer to the network resources being hosted by the POD is received over the public network by the firewall and provided over the private network to the content distributor which is configured to select a first server of the hosting servers, utilize the backup-restore application program to back up a starting configuration of the first server, and utilize the application program installer to apply the update to the network resources being hosted by the POD.

14. The system of claim 13, wherein the first network further communicatively couples a client, and wherein access attempts by the client for the network resources being hosted by the POD are received by the firewall and provided to the POD.

15. The system of claim 13, wherein the content distributor is further configured to perform determining whether to restore the starting configuration of the first server with the backup-restore application program.

16. The system of claim 13, wherein the content distributor is further configured to perform:
determining the application program installer incorrectly identified a successful installation of the update to the network resources of the client on the first server; and
restoring the starting configuration of the first server with the backup-restore application program.

17. The system of claim 13, wherein the content distributor is further configured to perform:
selecting a second server of the hosting servers; and
replicating the first server onto the second server after utilizing the application program installer to apply the update to the network resources of the client on the first server.

18. The system of claim 13, wherein the update comprises differences between the network resources of the client hosted by the POD and a new version of the network resources prepared by the client.

19. The system of claim 13, wherein the application program installer is utilized to install updates to selected ones of Internet data files, database records, and software applications.

20. A method comprising a new use for an application program installer operable to install an application program and rollback an installation if it appears unsuccessful, and a backup-restore application program operable to backup and restore a configuration of a machine, the method comprising:
providing an update for altering network resources of a customer being hosted on one or more hosting servers of a hosting service;
selecting a first server of the hosting servers;
backing up a starting configuration of the first server;
utilizing the application program installer to apply the update to the network resources of the customer on the first server; and
determining whether to restore the starting configuration of the first server with the backup-restore application program.

21. The new use method of claim 20, further comprising:
determining the application program installer incorrectly identified a successful installation of the update to the network resources of the customer on the first server; and
restoring the starting configuration of the first server with the backup-restore application program.

22. The new use method of claim 20, further comprising:
selecting a second server of the hosting servers; and
replicating the first server onto the second server after utilizing the application program installer to apply the update to the network resources of the customer on the first server.
